(19) United States
(12) Patent Application Publication
(10) Pub. No.: US 2005/0003059 A1
(43) Pub. Date: Jan. 6, 2005

(54) PACKAGING OF FOODSTUFFS

(75) Inventors: Brian Jay McFarlane, Hubbard, NE (US); Gary Edward Lockhorn, Plattsmouth, NE (US); John David Lukassen JR., Lowell, AR (US); Morrie G. Mildrum, Vermillion, SD (US)

Correspondence Address: BLACKWELL SANDERS PEPER MARTIN LLP, 720 OLIVE STREET, SUITE 2400, ST. LOUIS, MO, 63101, US

(73) Assignee: TYSON FRESH MEATS, INC., Dakota Dunes, SD (US)

(21) Appl. No.: 10/710,290

(22) Filed: Jun. 30, 2004

Related U.S. Application Data
(60) Provisional application No. 60/481,047, filed on Jul. 1, 2003.

(51) Int. Cl. A23C 1/00

(52) U.S. Cl. 426/404

(57) ABSTRACT

The present invention relates generally to a system for packaging foodstuffs such as beef, pork, seafood and poultry products wherein the system provides an apparatus and various methods for exposing the food products to one or more gases, or a blend of gases, in a series of steps controlling the pressure of the chamber during one or more flushing operations wherein at least some of the gas or gases associated with at least one flush are allowed to at least partially penetrate the structure of the food product, and thereafter sealing the food product in a container.

### CROSS REFERENCE TO RELATED APPLICATIONS

This application claims the benefit of U.S. Provisional Application Ser. No. 60/481,047 filed Jul. 1, 2003.

### BACKGROUND OF INVENTION

The present invention relates generally to the packaging of foodstuffs, for example, beef, pork, seafood and poultry, and is particularly useful with respect to the packaging of meat, especially beef. The purpose of packaging foodstuffs is primarily to protect foodstuffs during the distribution process, including storage and transport, from contamination, discoloration and to prevent spoilage. Some of the key factors that effect spoilage include temperature, microorganisms, light, moisture, oxygen and pH. The present invention is primarily directed to the protection of meat color and especially the prevention of metmyoglobin.

Oxygen affects meat and meat products by changing the color and causing oxidation and rancidity of fats and proteins causing undesirable off-flavors. Many packaging systems and concepts are currently available to package foodstuffs, for example, fresh beef, pork, poultry, and seafood products. Many of these systems include a modified atmosphere that may include varying ratios of different gases. Some of these systems are more specie specific than others and have intended purposes within the specie of muscle. Specifically in fresh beef and pork, the modified atmosphere packaging systems are predominately oxygen rich, that is, “high oxygen” or oxygen free, that is, “low oxygen” atmospheres are used. The oxygen rich atmosphere is used to develop and maintain the bright oxymyoglobin color for the duration of the product's life. An oxygen free atmosphere is used to fully reduce the product to a deoxymyoglobin form. Each system has its benefits and tribulations. In particular, with respect to beef, the high oxygen system maintains a bright cherry-red color for the entirety of the product's life; however, the product life is typically shorter than a low oxygen system. The low oxygen system allows product to be “bloomed” at specific times and results in a longer product life, in theory, allowing better management of the meat case. However, the low oxygen system does not result in as bright of cherry-red color as a high oxygen system.

In either system, the surface of the meat must not be exposed to very low levels of oxygen, especially between 500 to 1000 ppm. At these very low concentrations for short periods of time, unique color issues are created when packaging fresh beef. This low concentration of oxygen has been termed as “partial pressure” of oxygen. At a partial pressure of oxygen, irreversible metmyoglobin formation is created on the surface of the meat resulting in an unacceptable lean coloration which causes the product to be discounted or thrown away at the retail level. One common source of partial pressures of oxygen occurs when packaging materials (tray, soaker pad, film, etc.) contact the product in the package, such as the edge of the product touching the side of the tray preventing full oxygenation of the myoglobin. Typically, this is more prevalent when a barrier or non-permeable film is used. However, it can still be present when permeable film is used if the transmission rate of the film and/or atmosphere flushing process is not adequate.

There are two currently available technologies that have been demonstrated to successfully prevent partial pressures of oxygen in fresh beef. Exposing product to carbon monoxide at various concentrations (<0.1 to 100%) for various periods of time will result in a very strong bond with myoglobin forming carboxymyoglobin. Under constant atmospheric conditions containing carbon monoxide, this bond is nearly irreversible and will prevent metmyoglobin formation for extremely long periods of time. Secondly, exposing meat to 100% oxygen under high pressure (>200 psi) for extended periods of time (many hours) will saturate the musculature with oxygen resulting in excessive oxidation during storage in a high oxygen environment.

### SUMMARY OF INVENTION

The present invention relates generally to a system for packaging foodstuffs such as beef, pork, seafood and poultry. It is especially useful for packaging red meat, particularly beef. The system provides an apparatus and method for exposing the foodstuff to one or more gases in a pressurized environment. The pressurized environment may be achieved in a variety of ways including using various combinations of gas flushes and vacuum to allow at least some of the one or more gases to at least partially penetrate the meat structure. In one embodiment of the present invention, the foodstuff is placed on a container that is subjected to a vacuum. Once a predetermined vacuum is achieved, the container is flushed with oxygen, carbon monoxide, nitrogen or some other gas, either alone or in some blended combination of these gases, resulting in the flushed gas or gases being drawn into the structure of the meat. More particularly, at least one flush with a gas or blend of gases may occur before the food-stuff is finally flushed with a residual gas or blend of gases (modified atmosphere) for sealing purposes. The present system and method, therefore, provides for at least one flush of the foodstuff with one or more gases while the foodstuff is subjected to a controlled environment such as under a controlled chamber pressure.

Thus, the present invention relates to a method for the reduction of metmyoglobin formation in fresh packaged meat which comprises placing such meat under a controlled chamber pressure with one or more gases during its packaging process whereby such gas or gases penetrate the structure of the meat during at least one flushing operation and thereafter sealing such meat in a container.

Other variations and combinations of subjecting the food product to one or more vacuums, and/or to one or more flushes of a gas or gases for achieving the pressurized environment are also disclosed.

### BRIEF DESCRIPTION OF DRAWINGS

FIG. 1 illustrates a system for packaging foodstuffs in which the product flows through the unit, typically on a conveyor, and into the sealing chamber.

FIG. 2 illustrates the conveyance of the product in a container through a sealing chamber.

FIG. 3 illustrates the container within the sealing chamber with the chamber being in the open position.

FIG. 4 illustrates the container within the sealing chamber with the chamber being in the closed position and the atmosphere being evacuated from the chamber.

FIG. 5 illustrates the container within the sealing chamber with the chamber being in the closed position, the container being filled with the desired gas or gases through one of the two gas ports.

FIG. 6 illustrates the container within the sealing chamber with the chamber being in the closed position, the container being filled with the desired gas or gases through at least two separate gas ports.

### DETAILED DESCRIPTION

The present invention relates generally to a system for packaging foodstuffs such as beef, pork, seafood and poultry, and is especially useful for packaging red meat, particularly beef. The appearance of meat, and hence its acceptability by the consumer, can range from a desired bright cherry red color to purple to an unacceptable brown. A bright cherry red color is evidence that the myoglobin in the meat is in a state of oxymyoglobin. This state is very attractive to the consumer. In its reduced state, meat appears to be purple, that is, the state of deoxymyoglobin. This appearance is less attractive to the consumer. In the state of metmyoglobin, meat has a brown appearance and is very unattractive to the consumer, and it is perceived as being spoiled. The present invention provides an apparatus and various processes for reducing and/or preventing meat from being in the metmyoglobin state.

The system of the present invention provides an apparatus and various methods for exposing the foodstuff to one or more gases, or a blend of gases, in a series of steps involving controlling the pressure of the sealing chamber during one or more flushing operations. Thus, the present invention is directed to a method for the reduction of metmyoglobin formation in fresh packaged meat which comprises placing the meat under a controlled pressure environment with one or more gases during its packaging process whereby at least some of the gas or gases at least partially penetrates the structure of the meat, and thereafter sealing the meat in a container under a modified atmosphere, or with a vacuum seal.

In one embodiment of the present invention, a method and apparatus is provided for reducing the occurrence of metmyoglobin formation in fresh packaged meat by placing the meat on a container and introducing the container into a chamber, evacuating the atmosphere of the chamber to a predetermined pressure below atmospheric pressure by pulling a first vacuum, stopping the vacuum and simultaneously introducing a first flush of one or more gases within the chamber and into the container located therewithin at a pressure above atmospheric pressure, and continuing the introduction of the first flush of gas or gases until the chamber pressure reaches an elevated predetermined pressure. In this regard, it is contemplated that the first vacuum provided will evacuate the chamber atmosphere to a pressure that is less than 250 millibars, and preferably to a vacuum pressure of less than 75 millibars. It is also contemplated that the first flush of one or more gases into the chamber will generally start at a pressure above atmospheric pressure and will continue so as to raise the chamber pressure to a pressure above atmospheric pressure and, preferably, to a chamber pressure of at least 700 millibars. In a more preferred situation, the first flush of gas or gases will continue so as to raise the chamber pressure to at least 1,000 millibars. The chamber can be adapted with mechanisms to close off and substantially isolate the atmosphere of the chamber interior when pulling the vacuum.

As pressure in the chamber is built up with the flushed gases, it is recognized and anticipated that the pressure at which the first flush of gas or gases is being introduced into the chamber may have to be changed or increased as the chamber pressure rises so that the flushed gas or gases will continue to flow into the chamber. Since, in this embodiment, the first flush of one or more gases is initially introduced while the chamber is under a vacuum, and since at least a partial vacuum will continue to exist in the chamber until the pressure within the chamber reaches equilibrium with the gas or gases, the meat expansion created during this vacuum process will draw the gas or gases introduced during this first flush into the cell structure of the meat similar to a dry sponge soaking up water. Once the chamber pressure has reached its predetermined pressure above atmospheric pressure via the first flush of gas or gases, the first flush of gas or gases is stopped and the meat is maintained at this predetermined elevated pressure above atmospheric pressure for a predetermined period of time so as to further allow the gas or gases from the first flush to penetrate the meat structure. This predetermined time for holding the meat at a predetermined pressure above atmospheric pressure in the environment of the first flush of gas or gases may vary depending upon the type of gas or gases being used as well as depending upon the particular type of meat or foodstuff, or the particular cut of meat. It is generally anticipated that the meat product will be held within the environment of the first flush of gas or gases after the chamber pressure has reached its predetermined pressure for no more than ten minutes, preferably no more than one minute, and most preferably, no more than thirty seconds for an in-line packaging system. Here again, maintaining the meat in the environment of the first flush of gas or gases under pressure for a predetermined period of time will further facilitate the penetration of such gas or gases into the meat structure.

Upon expiration of the selected predetermined time period, the first flush of gas or gases is released and the atmosphere of the chamber may again be evacuated to a predetermined pressure below atmospheric pressure by pulling a second vacuum, stopping the second vacuum and simultaneously introducing a second flush of one or more gasses within the chamber and into the container positioned therewithin at a pressure at or above atmospheric pressure, and continuing the introduction of the second flush of gas or gases until the chamber pressure reaches a predetermined pressure. This second flush of gas or gases may be of the same gas or gases as the first flush, or it may comprise a gas or gases totally different than the first flush of gas or gases. Also, this second flush of gas or gases may be designed or patterned after the first flush of gas or gases so as to enable such second flush of gas or gases to likewise penetrate into the meat structure. If this is the case, the introduction of the second flush of gas or gases will likewise continue until the chamber pressure reaches a predetermined pressure which would again be above atmospheric pressure, at which time, the second flush of gas or gases will terminate and the meat product will be held within the environment of the second flush of gas or gases for a predetermined period of time. After expiration of this predetermined period of time, the second flush of gas or gases will likewise be released and any number of additional flushes along the lines identified above can be accomplished. On the other hand, if the second flush of gas or gases, or the final flush of gas or gases in a series of flushes, is to actually seal the meat within the container, this final flush of gas or gases will be initiated along with a sealing process and this final flush will contain the final modified atmosphere of gas or gases desired for the warranty period of the meat product. Since this modified atmosphere associated with the final flush will most likely be different from the gas or gases associated with any number of the previous flushes, a second set of gas ports and inlets are associated with the chamber so as to rapidly accomplish this final flush as will be hereinafter further explained.

Although certain embodiments of the present invention contemplate the use of two or more flushes of a single gas or a blend of gases as described above, the use of a first flush of gas or gases in accordance with the procedures set forth above so as to enable the first flush of gas or gases to penetrate into the meat structure followed by a final flush of a gas or gases to establish the modified atmosphere for sealing the container will achieve the stated objectives of the present invention. The use of multiple flushes of a gas or gases similar to the first flush described above may be utilized to further improve and/or facilitate the penetration of the flushed gas or gases into the meat structure, but such multiple flushes are optional. If multiple flushes are utilized, each additional successive flush of a gas or blend of gases may be accomplished at different pressures above atmospheric pressure, and even at pressures below atmospheric pressure, and such additional successive flushes may be continued to raise the chamber pressure to a wide variety of different predetermined pressures, either higher or lower than the chamber pressure achieved utilizing the first flush of a gas or gases. Still further, with respect to the final flush of a gas or blend of gases to achieve the modified atmosphere for sealing the meat product within the container, such final flush need only be continued so as to raise the chamber pressure to a sufficient and proper pressure so that the sealing process can be accomplished.

In another embodiment of the present invention, the first vacuum and first flush of one or more gases is accomplished as discussed above. Once the meat product has been subjected to the environment of the first flush of gas or gases under pressure at a predetermined chamber pressure above atmospheric pressure for a predetermined period of time, the first flush of gas or gases is released and simultaneously therewith a second flush of one or more gases is allowed to enter the chamber and purge and/or displace the gas or gases associated with the first flush. Depending upon the chamber pressure at which the gas or gases associated with the first flush are released, such release may be accomplished by merely opening a valve and equalizing the chamber pressure at atmospheric pressure, or a second vacuum may be pulled to evacuate the gases in the chamber and to likewise draw in the gas or gases associated with the second flush. This second flush of a gas or gases may continue until the gas or gases associated with the first flush are substantially evacuated from the chamber and/or until the chamber pressure reaches a predetermined pressure, either below, at or above atmospheric pressure. Here again, if this second flush of a gas or gases is to be the final flush establishing the modified atmosphere for sealing purposes, the chamber pressure is allowed to reach a pressure sufficient to properly seal the meat product within the container. Multiple flushes of a gas or blend of gases at a predetermined chamber pressure may likewise be accomplished between the first flush and the final flush in accordance with the parameters and procedures discussed above.

In still another embodiment of the present invention, a method and apparatus for reducing the occurrence of metmyoglobin formation in fresh packaged meat products includes placing the meat product on a container and introducing the container into a chamber, introducing a first flush of one or more gases within the chamber while the chamber and container are maintained under a first vacuum for a predetermined period of time wherein said gas or gases can at least partially penetrate into the meat structure, stopping the first flush of gas or gases and releasing the first vacuum, thereafter introducing a second flush of one or more gases within the chamber while the chamber and container are maintained under a second vacuum for a predetermined period of time, and thereafter sealing the container. As previously mentioned, the chamber can be equipped with mechanism for further closing off or isolating the interior atmosphere of the chamber. It is recognized that it will not be possible to maintain a vacuum at a specific pressure simultaneous with the introduction of a flushed gas or gases since the introduction of such flushed gas or gasses will change the pressure in the chamber pressure. Nevertheless, the pressure differential between the pressure at which the flushed gas or gases are introduced into the chamber and the vacuum pressure of the chamber at the time of such introduction will establish a sufficient pressure differential to enable the flushed gas or gases to at least partially penetrate into the meat structure. In this particular embodiment, the evacuation of the chamber by pulling a vacuum is continued during the time at which the flush of gas or gases is being introduced into the chamber. This is referred to as a simultaneous flush and vacuum operation. Depending upon the equipment being utilized, the integrity of the vacuum and control of the chamber pressure may vary. Also, in this particular application, the first flush of gas or gases may continue for a predetermined period of time sufficient to allow at least some of such gas or gases to penetrate into the meat structure, or such first flush of gas or gases may be continued until the chamber pressure reaches a predetermined pressure, at which time the first flush of gas or gases is terminated. The introduction of the second flush of one or more gases within the chamber may be conducted substantially identical to the introduction of the first flush of gas or gases, or such second flush of gas or gases may be the final flush of gas or gases so as to establish the modified atmosphere for sealing the container. As described above, multiple flushes of one or more gases may be utilized to allow the flushed gas or gases to penetrate into the meat structure prior to introduction of the final flush to establish the modified atmosphere for sealing purposes. In this regard, the final flush may be accomplished under vacuum as explained above, or the final flush may be conducted in accordance with the procedures outlined above wherein the final vacuum is stopped and introduction of the final flush of one or more gases occurs simultaneously therewith so as to raise the chamber pressure to a pressure sufficient to properly seal the container.

In still another embodiment of the present invention, a method is provided for the reduction of metmyoglobin formation in fresh packaged meat which comprises placing the meat product on a container and introducing the container and meat product into a chamber, introducing a first flush of one or more gases within the chamber while maintaining the chamber and the container under vacuum wherein the flushed gas or gases penetrate into the meat structure, maintaining the vacuum while stopping the first flush of gas or gases, introducing a second flush of one or more gases within the chamber wherein the second flush of gas or gases is allowed to penetrate into the meat structure, or such second flush of gas or gases will establish the modified atmosphere for sealing the container.

In still another embodiment of the present invention, it is also recognized that introduction of a gas or gases into the chamber for at least partial penetration into the meat structure may be accomplished without first pulling a vacuum and then introducing the first flush of gas or gases. A vacuum is utilized in many of the various embodiments discussed above so as to create a pressure differential between the chamber pressure and the pressure at which the first flush of gas or gases are introduced into the chamber. It is recognized that if the pressure differential between the chamber pressure and the pressure at which the first flush of gas or gases is introduced into the chamber is of sufficient magnitude, at least partial penetration of such gas or gases will still occur if the meat or other food product is exposed to that pressurized gas environment for some predetermined period of time as little as 10 seconds at 1000 psi. As a result, another embodiment of the present invention involves placing the meat on a container and introducing the container into a chamber, introducing a first flush of one or more gases within the chamber and into the container located therewithin at a pressure above atmospheric pressure, and continuing the introduction of the first flush of gas or gases until the chamber pressure reaches an predetermined elevated pressure. This predetermined elevated pressure may be as indicated above in the range of about 250 millibars to about 750 millibars, or it may be higher such as in the range of about 1000 millibars depending upon the meat product and depending upon the amount of time at which the meat product is left in the pressurized gas environment. Once the chamber pressure has reached its predetermined pressure above atmospheric pressure, the first flush of gas or gases is stopped and the meat is maintained at this predetermined elevated pressure above atmospheric pressure for a predetermined period of time so as to allow the gas or gases from the first flush to at least partially penetrate the meat structure. As discussed above, this predetermined time for holding the meat at a predetermined elevated pressure above atmospheric pressure in the environment of the first flush of gas or gases may vary depending upon the type of gas or gases being used as well as depending upon the particular type of meat of food stuff, or the particular cut of meat. Here again, it is anticipated that the meat product will be held within the environment of the first flush of gas or gases after the chamber pressure has reached its predetermined elevated pressure for no more than 10 minutes at 100 psi, preferably no more than 1 minute at 500 psi, and most preferably, no less than 30 seconds at 750 or more psi for an in-line packaging arrangement.

Upon expiration of the selected predetermined time period, the first flush of gas or gases is released and, if additional flushes of gas or gases are necessary, such additional flushes can be accomplished with or without a vacuum in accordance with the method described above. It is also recognized and anticipated that, depending upon the particular application, only one flush of pressurized gas for a selected predetermined time period may achieve sufficient penetration of the pressurized gas or gases into the meat structure to prevent the formation of metmyoglobin and the meat product and container can then be sealed. In this embodiment, the gas or gases utilized in the first and only flush could likewise establish the modified atmosphere for sealing purposes. In other words, no final flush of a gas or gases to establish the modified atmosphere for sealing the meat product and container will be necessary if the first flush of gas or gases is also sufficient to establish this modified atmosphere or if no atmosphere is needed prior to sealing the container. On the other hand, if a second or final flush of a gas or gases is necessary to establish the final modified atmosphere for sealing the meat product within the container, this final flush of gas or gases can likewise be accomplished with or without a vacuum and once the chamber pressure is allowed to reach a pressure sufficient to properly seal the meat product within the container with the modified atmosphere, the sealing process is accomplished. In its broadest concept, this particular embodiment of the present invention requires only one pressurized flush of a gas or gases for a predetermined period of time at a predetermined elevated pressure and then the meat product and container are sealed via conventional means.

Although all of the sealing steps discussed above involve sealing the meat product within the container with a modified atmosphere after a final flush of an appropriate gas or gases, it is also recognized and anticipated that all of the various embodiments of the present invention discussed above can be sealed via a vacuum seal process. In this case, a final flush of an appropriate gas or gases to establish a modified atmosphere is not necessary and can be deleted from all of the various methods discussed above. Instead, once the one or more flushes of one or more gases is completed and sufficient penetration of at least some of such gas or gases is achieved, the final flush of gas or gases is released and a vacuum seal is accomplished. This would involve pulling a vacuum just prior to the sealing process so as to draw or shrink wrap the sealing material or film around the meat product and container in a conventional vacuum packaging manner. As a result, depending upon the type of sealing process utilized, sealing may occur either with or without a vacuum.

In yet another embodiment of the present invention, an apparatus is provided for accomplishing the various flushes of gas or gases as described above for reducing metmyoglobin formation in the packaging of fresh meat products. In the known apparatus for accomplishing the packaging and sealing of the type of containers with meat products placed therein as discussed above, such apparatus typically include only a single gas post for introducing a gas or combination of gases into the sealing chamber. This arrangement slows down the overall packaging process in that only one gas or one blend of gases may be introduced into the chamber. If a different gas or a different blend of gases is required to be likewise introduced into a particular container during the packaging process, canisters or other containers containing the different gas or different blend of gases must be connected to the single gas port for introduction into the chamber. This means that the canisters containing the previous gas or gases must be disconnected from the system and new canisters must be reconnected. This is time consuming and, in an in-line tray or container lidding packaging process, is not feasible since a multitude of trays or containers containing food products are moving on a conveyor system into and out of the chamber. As a result, the present apparatus includes at least two separate gas ports for introducing two separate gases or two separate blends of gases simultaneously or sequentially into the sealing chamber. As a result, any of the various flushes of a gas or blend of gases referred to above with respect to any of the various embodiments of the present invention can be accomplished using two or more separate gas ports as will be hereinafter further explained. For example, one or more gases may be introduced into the chamber via a first gas port and simultaneously therewith one or more gases may be introduced into the chamber via a second gas port, or via a plurality of other gas ports. Also, a particular blend of gases could be accomplished by using two or more gas ports, for example, one port introducing one gas and another port introducing another gas. Still further, the introduction of the gases through the two or more separate gas ports could be timed and/or programmed such that the proper mixture or ratio of gases is introduced into the sealing chamber. It is also anticipated and recognized that the particular gas or blend of gases utilized for penetration into the meat structure can be accomplished using one of the available gas ports and the final flush of gas or gases which will establish the modified atmosphere for sealing the meat product within the container can be introduced through another gas port. This arrangement significantly reduces the time required for each container to remain within the sealing chamber during the multiple vacuum/flush operations.

A critical aspect of the present invention is the introduction of the gas into the meat structure. By the term “meat structure” is meant the tissue, especially the muscle tissue, of the meat including the tissue of poultry and seafood. In this regard, although the above discussions of the various methods of the present invention are specifically directed to beef products, it is to be understood that use of the term “meat” throughout this specification and in the claims is also meant to specifically include pork, poultry and seafood products.

One aspect of the present invention is that penetration of the gas or gases into the meat structure must be accomplished in a relatively short period of time, particularly if the foodstuff is being packaged in an in-line process. The present invention, therefore, contemplates that introducing the gas or gases into the chamber and allowing at least some of the flushed gas or gases to penetrate into the meat structure will occur in 10 minutes or less. It is preferred that this time period be 1 minute or less, and it is most preferred that this time period be 30 seconds or less. Thus, in one aspect of the present invention the oxymyoglobin state, that is, the cherry red color of the meat is maintained by providing one or more gases to the meat product in a controlled and pressurized environment such that a sufficient amount of such gas or gases penetrate the meat structure in minimum time to prevent and/or reduce metmyoglobin formation. This can be accomplished by providing a vacuum during the gas penetration process and/or controlling the chamber pressure in other ways as explained above. It is not necessary that the meat be fully penetrated or saturated with the gas, but it must penetrate the meat surface sufficiently to maintain the cherry red color.

It is also recognized and understood that use of the term “container” throughout this specification and in the claims is meant to include, but is not limited to, all types of containers for packaging beef, pork, poultry and seafood such as trays, bags, and other holding means for packaging food products.

In accordance with one aspect of the present invention, the gases used as a flush include, but are not limited to, oxygen, carbon monoxide, nitrogen and carbon dioxide, either individually or in any combination or blend thereof. As noted above, the present invention contemplates expansion of the meat due to subjecting the meat to a vacuum, or to a pressure environment, such that the gases are introduced into the structure of the meat. To achieve this, generally, the vacuum provided must be less than 500 millibars. Preferably, it will be less than 100 millibars. The flush of gas or gases is generally started at a pressure above the chamber pressure and is continued so as to raise the chamber pressure to a predetermined pressure which, depending upon the particular situation and where the flush is in a series of flushes, may be below, at, or above atmospheric pressure, and depending upon whether a vacuum is simultaneously maintained during the flush. Most preferably, the flushes designed to allow the gas or gases to penetrate the meat structure will be conducted so as to raise the chamber pressure to at least 100 millibars unless a vacuum is simultaneously maintained during the flush. Other embodiments of the present invention provide a pressurized environment without pulling a vacuum as explained above.

It should be recognized that the container used to hold the foodstuff can take on a wide variety of different constructions as explained above and that such container, especially if the foodstuff is a meat product, must be of sufficient density to prevent seepage of any liquid. Such containers can be constructed of polypropylene or copolymers of polypropylene and polyvinlyidene chloride. Other high density polymers, such as high-density polyethylene could also be used. Furthermore, the containers can be constructed of foam, such as polystyrene, polypropylene, polyvinylchloride and the like. Films for sealing the meat product can be made of polyvinylchloride, polyethylene or polypropylene but polyvinylidenchloride, polyester, polyamide and cellulose film are preferred.

The method and apparatus can be further described by referring to the accompanying Figures.

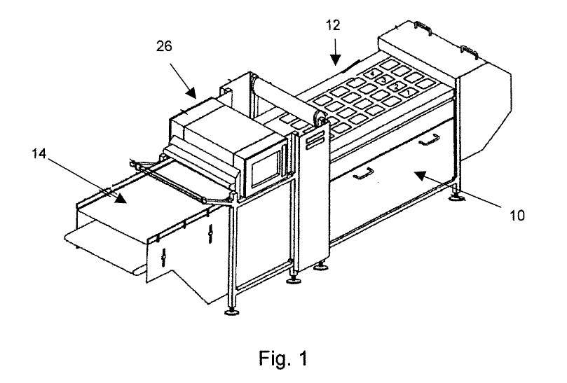

FIG. 1 illustrates a system for packaging foodstuffs in which the product flows through the unit 10, typically on a conveyor 12, and into the sealing chamber 26. The containers (not shown in FIG. 1) are placed on the conveyor 12 and introduced into the chamber 26. After being sealed, the containers exit the chamber 26 and are discharged via the discharge chute 14.

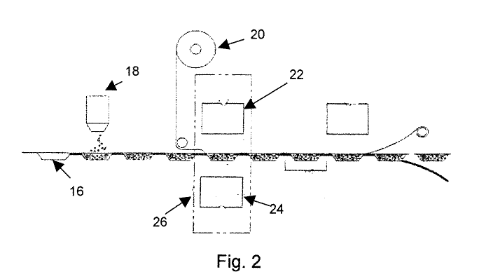

FIG. 2 illustrates the conveyance of the product in a container through a sealing chamber. More particularly, containers 16 are filled with the appropriate foodstuff by filler 18 and conveyed between an upper chamber portion 22 and a lower chamber portion 24. The chamber portions 22 and 24, when closed, form sealing chamber 26. When the chamber 26 is closed, the container 16 with foodstuff located therewithin is subjected to one or more gas flushes as previously explained and the container is thereafter sealed via film roll 20.

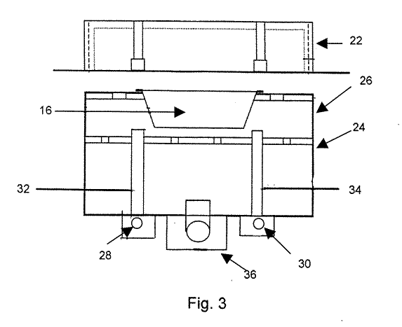

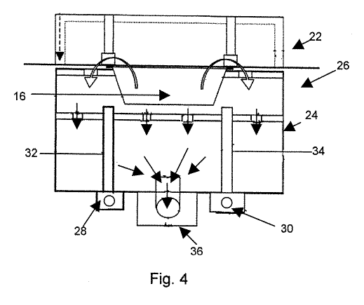

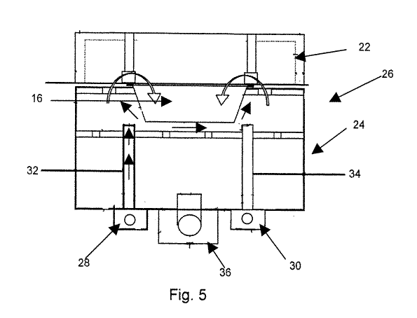

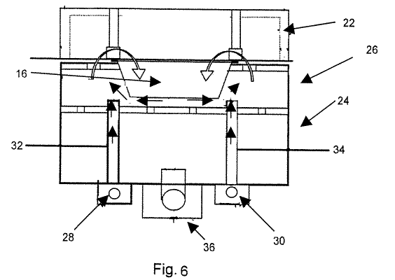

FIG. 3 and FIG. 4 illustrate the container 16 within the chamber 26 with the chamber being in its open position in FIG. 3 and in its closed position in FIG. 4. The chamber 26 is comprised of the upper chamber portion 22 and the lower chamber portion 24 within which the container 16 sits. The lower chamber 24 contains two or more gas ports 28 and 30 each being connected to a respective gas tube such as gas tubes 32 and 34 through which gas can be introduced into the chamber 26 when closed as depicted in FIGS. 5 and 6. The lower chamber 24 further includes a vacuum port 36 through which the atmosphere in the chamber 26 when closed can be evacuated as shown in FIG. 4. While the vacuum port 36 and the gas ports 28 and 30 are shown as being positioned and located in the lower chamber 24, it will be understood and appreciated that any or all of them could be associated with the upper chamber 22, or anywhere within the chamber 26. The chamber 26 as shown in FIGS. 3, 4 and 5 has an upper 22 and lower 24 portion that engage to form chamber 26. However, alternatively, chamber 26 can be a flow through chamber having an entry and an exit portal through which the containers can be conveyed for entry into the chamber and exiting the chamber. The entry and exit portals can be designed with the appropriate flaps, constraints or baffles, as are well known by those skilled in the art, to create a substantially isolated chamber 26 environment, such that an appropriate vacuum can be pulled in the chamber. Pulling a vacuum in chamber 26 can be a two step process when utilizing the apparatus of FIGS. 3-5 and they are 1.) Engaging the upper 22 and lower 24 portions and 2.) Pulling the vacuum. However, pulling the vacuum is a one step process in the case of a flow through system. There can be various other configurations of the chamber 26, which can be envisioned, but do not depart from the spirit and scope of the present invention.

FIG. 5 illustrates the container 16 within the sealing chamber 26 with the chamber being in its closed position, the container 16 being filled with the desired gas or blend of gases through the primary gas port 28 and its associated gas tube 32. Although FIG. 5 shows the container being filled with the desired gas or gases through primary gas port 28 only, it is recognized and anticipated that container 16 can be filled with the desired gas or gases through the use of secondary gas port 30, or through the use of both gas ports 28 and 30 as illustrated in FIG. 6. Although FIG. 5 shows the vacuum port 36 in its closed position, it is also recognized and anticipated that, as explained above, the introduction of a particular flush of gases may be accomplished while simultaneously pulling a vacuum.

FIG. 6 illustrates the container 16 within the sealing chamber 26 with the chamber being in its closed position, the container 16 being filled with the desired gas or blend of gases through the primary gas port 28 and its associated gas tube 32 as well as through the secondary gas port 30 and its associated gas tube 34 while the sealing chamber is being simultaneously evacuated via the vacuum port 36. Although FIG. 6 shows the container being filled with the desired gas or gases through both gas ports 28 and 30, it is recognized that the container 16 can be filled with the desired gas or gases through the use of only one gas port and that different gases or blends of gases may be associated with each gas port 28 and 30. Also, as explained above, the introduction of a particular flush of gases may be accomplished without simultaneously pulling a vacuum as shown in FIG. 5. Although not illustrated, it is also recognized and anticipated that the chamber 26 may include any number of gas ports and associated plumbing.

As may be understood by those skilled in the art, the present invention contemplates several different processes. For example the chamber 26 can be a flow through chamber as described above as opposed to a chamber created by the engagement of an upper and lower half. In addition, for example, the meat product could undergo a series of sequential flushes with the same gas, with and without one or more vacuums. In another embodiment, the meat product could undergo a series of sequential flushes with different gases, with and without one or more vacuums. Still another embodiment of the present invention contemplates multiple flushes with different gases simultaneously, with and without one or more vacuums. Still further, another embodiment of the present invention contemplates a single flush of pressurized gas or gases, with and without using a vacuum to achieve the proper pressure, and thereafter sealing the meat product within the container. Also, as previously indicated, the gases can be introduced into the chamber via one or both of the gas ports 28 and 30, or via any plurality of gas ports. In each of the embodiments of the present invention, at least one flush is provided under the parameters set forth above so that at least some of the gas or gases associated with that at least one flush penetrates into the structure of the meat. A preferred embodiment of the invention contemplates a first flush of the meat product with carbon monoxide or oxygen, followed by a final sealing flush of the meat product with a mixture of nitrogen, carbon dioxide, oxygen and possibly carbon monoxide wherein a sufficient amount of the first flush of gas penetrates into the structure of the meat product to reduce and/or prevent metmyoglobin formation.

It is also anticipated that prior to the final sealing flush for establishing the modified atmosphere within the container 16, the meat product and container can be flushed with an anti-microbial gas which will reduce and/or facilitate prevention of microbial growth once the meat product is sealed and packaged. After this anti-microbial flush is accomplished, the final sealing flush can occur. In this particular scenario, a series of at least three flushes of various gases may occur in order to accomplish the stated objectives, namely, at least one flush of a gas or gases wherein at least a portion of such flushed gas or gases penetrate the meat structure, a second flush of an anti-microbial gas and a third flush of a residual gas for establishing the modified atmosphere for sealing. It is also recognized that the anti-microbial gas could be included in the final flush and could be part of the modified atmosphere. In this situation, a separate flush with just an anti-microbial agent could be avoided. It is also recognized that both the anti-microbial gas and the gas or gases establishing the modified atmosphere may likewise be included in the first flush thereby eliminating the second and third flushes. Other combinations are likewise possible.

Although the present invention has been described and disclosed primarily with respect to packaging meat products with an in-line packaging machine system similar to the apparatus disclosed in FIGS. 1-6, it is also anticipated that the present methods could likewise be utilized in a batch system wherein the various meat products would be subjected to at least one flush of a gas or gases for a predetermined period of time to achieve penetration of at least some of such gas or gases into the meat structure following which the meat products would be removed from the batch system and packaged and sealed in a modified atmosphere. In a batch process, the meat products may be subjected to the flushed gas or gases for greater than 10 minutes such as, for example, for 60 minutes or less before moving the meat product to a sealing process.

Although the present invention has been described and disclosed primarily with respect to meat products, as defined above, the terms “meat” and “meat structure” are meant to include the tissue of poultry and seafood as well. All of the above described various methods for protecting a particular food product from contamination, discoloration and spoilage are equally applicable to poultry and seafood and all such methods work equally as well in preserving and protecting the color of the poultry or seafood products being packaged and likewise help to prevent discoloration, oxidation and rancidity of fats and proteins causing undesirable off-flavors.

Although the present invention describes two types of chambers, the chamber in FIGS. 3-5 and the flow through chamber, various other inline and batch type chamber systems can be envisioned and fall within the spirit and scope of the present invention. For example, the chamber can be an elongated duct or conduit opened on opposing ends through which containers can be conveyed. Various ports and associated tubes can be communicably linked to the duct or channels for introducing gases or for pulling a vacuum. The conveyor, which conveys the containers through the duct or conduit can be equipped with plunger or piston like partitions position on either side (upstream and downstream) of each of the containers being conveyed such that a substantially isolated volume is created between the partitions for pulling a vacuum and introducing gases.

The present invention therefore contemplates the reduction of metmyoglobin by ensuring that the foodstuff, especially a red meat product, is sufficiently saturated with one or more gases by introducing the gas under pressure for a predetermined period of time. Sufficient saturation of the meat product is accomplished by one or more pressurized gas flushes. By reducing the production of metmyoglobin, the present process produces color and muscle quality benefits and minimizes or eliminates discoloration of the meat product due to contact with the container or the film.

Thus, there has been shown and described several embodiments of a novel method and apparatus for reducing and/or preventing the formation of metmyoglobin in a food product, which methods and apparatus fulfill all of the objects and advantages sought therefore. Many changes, modifications, variations and other uses and applications of the present methods and apparatus, including equivalents thereof, will, however, become apparent to those skilled in the art after considering this specification and the accompanying drawings. All such changes, modifications, variations, equivalents and other uses and applications which do not depart from the spirit and scope of the present invention are deemed to be covered by the invention which is limited only by the claims which follow.

1. A method for packaging a foodstuff which comprises placing said foodstuff in a chamber during its packaging process, providing under pressure at least one flush of one or more gases to said foodstuff whereby at least some of said gas or gases from said at least one flush at least partially penetrates the structure of the food-stuff within a predetermined time, and thereafter sealing said foodstuff in a container.

2. A method for packaging fresh meat comprising placing the meat on a container and introducing said container into a chamber, closing the chamber, subjecting said container to a first vacuum, introducing a first flush of one or more gases within said container and holding said meat within the environment of said first flush of one or more gases for a predetermined period of time wherein said one or more gases at least partially penetrate the meat structure, releasing said first flush of one or more gases, introducing a second flush of one or more gases within said chamber for a predetermined period of time, and sealing said meat within said container with one or more of the gases introduced from said second flush.

3. The method according to claim 2 wherein the gas or gases introduced during the second flush is the same as the gas or gases introduced during the first flush.

4. The method according to claim 2 wherein the gas or gases introduced during the first flush is selected from the group consisting of oxygen, carbon monoxide, nitrogen and carbon dioxide.

5. A method for the reduction of metmyoglobin formation in fresh packaged meat comprising placing the meat on a container and introducing said container into a chamber, evacuating the atmosphere of said chamber to a predetermined pressure below atmospheric pressure by pulling a first vacuum, stopping said first vacuum, introducing a first flush of one or more gases within said chamber at a pressure above atmospheric pressure and continuing the introduction of said first flush until the chamber pressure reaches a predetermined pressure, stopping the first flush of one or more gases, maintaining the meat within the environment of the first flush of gas or gases at this predetermined chamber pressure for a predetermined period of time so as to allow at least some of the gas or gases from said first flush to at least partially penetrate the meat structure, releasing the first flush of gas or gases from the chamber, evacuating the atmosphere of the chamber to a second predetermined pressure by pulling a second vacuum, stopping the second vacuum, introducing a second flush of one or more gases within the chamber at a predetermined pressure and continuing the introduction of said second flush of gas or gases until the chamber pressure reaches a predetermined pressure, and thereafter sealing the meat within said container.

6. The method according to claim 5 wherein said meat is held within the environment of said second flush of gas or gases for a predetermined period of time, releasing said second flush of gas or gases, evacuating the atmosphere of said chamber to a predetermined pressure by pulling a third vacuum, stopping the third vacuum, and introducing a third flush of one or more gases within said chamber, continuing the introduction of said third flush of gas or gases until the chamber pressure reaches a predetermined pressure, said meat being thereafter sealed within said container with at least some of the gas or gases associated with said third flush.

7. The method according to claim 5 wherein said first vacuum is at a pressure which is less than 500 millibars.

8. The method according to claim 5 wherein said first vacuum is at a pressure which is less than 100 millibars.

9. The method according to claim 5 wherein said first flush of gas or gases is allowed to raise the chamber pressure to a predetermined pressure above atmospheric pressure.

10. The method according to claim 9 wherein said predetermined chamber pressure is at least 250 psi.

11. The method according to claim 5 wherein said meat is held within the environment of said first flush for no more than ten minutes.

12. The method according to claim 5 wherein the introduction of said second flush of gas or gases is allowed to raise the chamber pressure to at least atmospheric pressure.

13. The method according to claim 5 including performing any plurality of first vacuums and first flushes prior to conducting said second vacuum and said second flush.

14. A method for the reduction of metmyoglobin formation in fresh packaged meat comprising placing the meat on a container and introducing said container into a chamber, evacuating the atmosphere of said chamber to a predetermined pressure below atmospheric pressure by pulling a first vacuum, stopping said first vacuum, introducing a first flush of one or more gases within said chamber at a pressure above atmospheric pressure and continuing the introduction of said first flush until the chamber pressure reaches a predetermined pressure, stopping the first flush of gas or gases, maintaining the meat within the environment of the first flush of gas or gases at this predetermined chamber pressure for a predetermined period of time so as to allow at least some of the gas or gases from said first flush to at least partially penetrate the meat structure, releasing the first flush of gas or gases from the chamber and simultaneously therewith introducing a second flush of one or more gases, continuing the introduction of said second flush of gas or gases until the chamber pressure reaches a predetermined pressure, and thereafter sealing the meat within said container.

15. The method according to claim 14 wherein said first vacuum evacuates the chamber to a pressure less than 500 millibars.

16. A method for packaging foodstuff which comprises placing the foodstuff on a container and introducing said container into a chamber, introducing a first flush of one or more gases within said chamber while said container is maintained under a first vacuum wherein at least some of the gas or gases penetrate into the structure of the foodstuff, stopping the first flush of gas or gases and releasing said first vacuum, introducing a second flush of one or more gases within said chamber while said container is maintained under a second vacuum.

17. The method according to claim 16 wherein the gas or gases introduced during the second flush is the same as the gas or gases introduced during the first flush.

18. The method according to claim 16 wherein one or more gases are selected from the group consisting of oxygen, carbon monoxide, nitrogen and carbon dioxide.

19. The method according to claim 16 wherein said first and second vacuums are at a pressure from about 500 millibars to about 100 millibars.

20. The method according to claim 16 wherein said gas or gases are introduced at a pressure above the chamber pressure.

21. The method according to claim 20 wherein said gas or gases raise the chamber pressure to a predetermined chamber pressure.

22. The method according to claim 16 wherein said second flush includes an anti-microbial gas, and further including stopping the second flush of one or more gases and releasing said second vacuum, introducing a third flush of one or more gases within the chamber while said container is maintained under a third vacuum, stopping the third flush of one or more gases, and sealing the container with the meat and at least some of the gas or gases from said third flush.

23. The method according to claim 16 wherein said second flush includes the modified atmosphere for sealing the foodstuff within the container, stopping the second flush of one or more gases and sealing the container with the foodstuff and at least some of the modified atmosphere from said second flush.

24. A method for the reduction of metmyoglobin formation in fresh packaged meat which comprises placing the meat on a container and introducing said container into a chamber, introducing a first flush of one or more gases within said chamber while maintaining said container under vacuum wherein said gas or gases are allowed to at least partially penetrate into the meat structure, maintaining the vacuum while stopping the first flush of gas or gases, and thereafter introducing a second flush of one or more gases within said chamber while still maintaining said vacuum, stopping said second flush of gas or gases, and sealing said container with the meat and at least some of the gas or gases from said second flush.

25. A method for packaging fresh meat comprising placing the meat on a container and introducing said container into a chamber, introducing a first flush of one or more gases within said chamber while maintaining said container under vacuum wherein at least some of said gas or gases are allowed to at least partially penetrate into the meat structure, maintaining said vacuum while stopping the first flush of gas or gases, introducing any number of additional flushes of one or more gases within the chamber while still maintaining said vacuum wherein at least some of said gas or gases from said additional flushes are allowed to at least partially penetrate into the meat structure, maintaining said vacuum while respectively stopping each of said additional flushes of gas or gases, and thereafter introducing a final flush of one or more gases within said chamber while still maintaining said vacuum, stopping said final flush of gas or gases, and sealing said container with the meat and at least some of the gas or gases from said final flush.

26. A method for packaging fresh meat which comprises placing the meat on a container and introducing said container into a chamber, introducing one or more gases within said chamber via a first gas port associated with said chamber while maintaining said container under vacuum wherein at least some of said gas or gases are allowed to at least partially penetrate into the meat structure and simultaneously introducing one or more gases within said chamber via a second gas port associated with said chamber wherein at least some of said gas or gases are allowed to at least partially penetrate into the meat structure.

27. Apparatus for packaging fresh meat comprising a packaging system which includes a first chamber and a second chamber adapted to hold one or more containers, means for isolating the atmosphere of said first and second chambers about said container to create a defined space around said container, a vacuum port for creating a vacuum within said defined space when said first and second chambers are closed about said container, at least two gas ports for introducing one or more gases into said defined space when said first and second chambers are closed about said container, and means to seal said container.

28. The apparatus according to claim 27 wherein said apparatus includes a plurality of gas ports for introducing one or more gases into said defined space when said first and second chambers are closed.

29. Packaged meat which comprises meat containing one or more gases within its structure as a result of said meat having undergone one or more flushes with a gas or gases while said meat is subjected to vacuum.

30. Packaged meat processed according to the methods of claims 1, 2, 5, 14, 16, 22, 24, 25 and 26.

31. A method for packaging fresh meat comprising placing the meat on a container and introducing said container into a chamber, subjecting said container to a first vacuum, introducing a first flush of one or more gases within said container and holding said meat within the environment of said first flush of one or more gases for a predetermined period of time wherein said one or more gases at least partially penetrate the meat structure, releasing the first flush of one or more gases, introducing any number of additional flushes of one or more gases within the chamber and respectively holding said meat within the environment of each respective additional flush of one or more gases for a predetermined period of time, and sealing said meat within said container with one or more of the gases introduced from said final flush.

32. A method for packaging fresh meat comprising placing the meat on a container and introducing said container into a chamber, evacuating the atmosphere of said chamber to a predetermined pressure below atmospheric pressure by pulling a first vacuum, stopping said first vacuum, introducing a first flush of one or more gases within said chamber at a pressure above atmospheric pressure and continuing the introduction of said first flush until the chamber pressure reaches a predetermined pressure, stopping the first flush of gas or gases, maintaining the meat within the environment of the first flush of gas or gases at this predetermined chamber pressure for a predetermined period of time, releasing the first flush of gas or gases from the chamber, introducing any number of additional flushes of one or more gases within the chamber at a predetermined pressure after first respectively evacuating the atmosphere of the chamber to a predetermined pressure by pulling a respective vacuum prior to the introduction of each additional flush, and continuing the introduction of each additional flush of one or more gases until the chamber pressure reaches a predetermined pressure, and thereafter sealing the meat within said container.

33. A method for packaging foodstuff comprising placing the foodstuff on a container and introducing said container into a chamber, introducing a first flush of one or more gases within said chamber while said container is maintained under a first vacuum, stopping the first flush of gas or gases and releasing said first vacuum, introducing any number of additional flushes of one or more gases within the chamber while said container is maintained under a corresponding number of respective vacuums, stopping each respective flush of gas or gases and releasing the corresponding respective vacuum, and thereafter sealing the foodstuff within said container.

34. A method for packaging fresh meat which comprises placing the meat on a container and introducing said container into a chamber, introducing one or more gases within said chamber via a first gas port associated with said chamber, and simultaneously introducing one or more gases within said chamber via a second gas port associated with said chamber.

35. A method for packing fresh meat comprising placing the meat on a container and introducing said container into a chamber, evacuating the atmosphere of said chamber to a predetermined pressure below atmospheric pressure by pulling a first vacuum, stopping said first vacuum, introducing a first flush of one or more gases within said chamber at a pressure above atmospheric pressure and continuing the introduction of said first flush until the chamber pressure reaches a predetermined pressure, stopping the first flush of one or more gases, maintaining the meat within the environment of the first flush of gas or gases at this predetermined chamber pressure for a predetermined period of time so as to allow at least some of the gas or gases from said first flush to at least partially penetrate the meat structure, releasing the first flush of gas or gases from the chamber, and thereafter sealing the meat within said container.

36. The method according to claim 35 wherein said first flush of one or more gases includes an anti-microbial gas.

37. The method according to claim 35 wherein said first flush or one or more gases includes the modified atmosphere for sealing the meat within the container.

38. The method according to claim 35 including evacuating the atmosphere of said chamber to a predetermined pressure below atmospheric pressure by pulling a second vacuum after the first flush of gas or gases are released from said chamber, and thereafter vacuum sealing the meat within said container.

39. A method for packaging meat comprising placing the meat on a container and introducing said container into a chamber, introducing a flush of one or more gases within said chamber at a pressure above said initial chamber pressure, continuing the introduction of said flush until the chamber pressure reaches a predetermined elevated pressure, stopping the flush of one or more gases, maintaining the meat within the environment of said flush of gas or gases at this predetermined elevated chamber pressure for a predetermined period of time so as to allow at least some of the gas or gases from said flush to at least partially penetrate the meat structure, releasing the flush of gas or gases from the chamber, and thereafter sealing the meat within said container.

40. The method according to claim 39 wherein said flush of one or more gases includes an anti-microbial gas.

41. The method according to claim 39 wherein said flush of one or more gases includes the modified atmosphere for sealing the meat within the container.

42. The method according to claim 39 including evacuating the atmosphere of said chamber to a predetermined pressure below atmospheric pressure by pulling a vacuum after the flush of gas or gases are released from said chamber, and thereafter vacuum sealing the meat within said container.

43. A method for packaging a foodstuff comprising placing said foodstuff under a vacuum during its packaging process, providing under pressure at least one flush of one or more gases to said foodstuff whereby at least some of said gas or gases from said at least one flush at least partially penetrates the structure of the foodstuff within a predetermined time, and thereafter sealing said food-stuff in a container.

44. The method according to claims 1 and 43 wherein the foodstuff is meat.

45. The method according to claims 1 and 43 wherein the foodstuff is fish.

46. The method according to claims 1 and 43 wherein the foodstuff is poultry.

47. Packaged meat processed according to the methods of claims 31, 32, 33, 34, 35, 39 and 43.
